(19) United States
(12) Patent Application Publication
(10) Pub. No.: US 2012/0187219 A1
(43) Pub. Date: Jul. 26, 2012

(54) ROTARY PULSATING VALVE AND METHOD FOR DISCHARGING FLUID

(76) Inventors: Frank J. CRISCIONE II, Kansas City, MO (US); Ronnie Lee Avey, Gladstone, MO (US); Oliver Hahn, Parkville, MO (US); Victor Elstin, Overland Park, KS (US)

(21) Appl. No.: 13/358,883

(22) Filed: Jan. 26, 2012

Related U.S. Application Data
(60) Provisional application No. 61/436,480, filed on Jan. 26, 2011.
(60) Provisional application No. 61/540,831, filed on Sep. 29, 2011.

(51) Int. Cl. B67D 7/06; A62C 31/00

(52) U.S. Cl. 239/436; 251/304

(57) ABSTRACT

A valve for providing a pulsating discharge of fluid includes a valve assembly rotatably received within a housing. The housing is a tubular chamber with a fluid inlet port at a back end, a plurality of fluid outlet ports at a front end, with the valve assembly in between. The valve includes a lower body disposed adjacent the front end, and includes a plurality of valve openings that sequentially rotate into and out of communication with the fluid outlet ports as the valve assembly is rotated thereby causing a sequential discharge of fluid from the tubular chamber. The valve openings may have various dimensions thereby causing a variation in the pulsating fluid discharge effect. The distance between the valve lower body and the fluid outlet ports may be increased or decreased to allow uninterrupted fluid flow out of the tubular chamber and through the plurality of fluid outlet ports.

### CROSS-REFERENCE TO RELATED APPLICATIONS

This application claims the benefit of U.S. Provisional Patent Application No. 61/436,480, filed Jan. 26, 2011, and U.S. Provisional Patent Application No. 61/540,831, filed Sep. 29, 2011, which are incorporated herein by reference.

### BACKGROUND OF THE INVENTION

The present disclosed technology relates to devices for discharging fluid, such as valves for water sprayers used in connection with cleaning items in, for example food processing systems. More specifically, the present technology concerns rotary valves providing a pulsating discharge of fluid for cleaning items.

In food processing facilities where animal carcasses are processed and packaged, fluid, such as water, is used to wash and irrigate parts, such as chickens, to ensure that the food parts are clean and free of debris. To ensure a thorough cleaning, it is desirable for water to be provided in a stream of sufficient pressure for effective washing and irrigation. Furthermore, given that much of the food processing occurs in stages that take place at various stations requiring transportation of food parts by a conveyor system, it is desirable to provide the source of water through spray heads so that washing and irrigation can be done as parts are conveyed along the conveyor system as well as at respective stations. As such, a large amount of water is used in processing operations and is therefore a large portion of the cost of operations.

### SUMMARY

There is, therefore, provided in the practice of the disclosed subject matter an apparatus for providing a pulsating discharge of fluid from a housing having multiple fluid discharge nozzles. In accordance with an aspect of the disclosed subject matter, a rotary pulsator assembly comprises a housing having a rotatable valve assembly disposed therein. As the valve assembly is rotated, openings in the valve assembly pass along a rotational path within a chamber of the housing transitioning the valve openings into sequential communication with a series of fluid outlet ports provided at a discharge area in the housing. As each valve opening communicates with a fluid outlet port, a burst of liquid is discharged from the fluid discharge nozzle and then terminates as the valve opening rotates out of communication with the fluid outlet port. While the valve assembly is rotating, the valve opening remains over and in fluid communication with the fluid outlet port for only a brief moment before it passes to the next fluid outlet port in the rotational path. In this manner, the fluid discharge from the housing manifests itself as a pulsating fluid discharge that sequentially follows the annular array of fluid discharge nozzles, and repeats the pulse discharges from each fluid outlet port as each valve opening passes over that fluid outlet port followed by the closing of the outlet port by the valve body. As a result, sprayers connected to the rotary pulsating assembly discharge fluid in a pulsating manner.

In accordance with another embodiment of the disclosed subject matter, the valve openings are configured with a dimension that can cause a variation in the pulsating fluid discharge effect. For example, a valve opening forming a smaller sized aperture will yield a fluid discharge burst of relatively shorter duration such that the pulse effect is one of flashing from the fluid outlet port. In another embodiment of the disclosed subject matter, the valve openings may form an arcuate shape such that the valve opening will remain for a somewhat longer duration of alignment with the fluid outlet port to yield a fluid discharge burst of relatively longer duration to create a staggered pulse effect as the sequential fluid discharge bursts pass from fluid discharge nozzle to fluid discharge nozzle. To enhance the staggered effect, the arcuate shaped valve openings can be constructed to have a greater length such that the fluid outlet port remains open for a greater duration as the valve assembly is rotated.

The pulsating effect created by the rotary pulsator assembly helps to create a more efficient washing effect. The pulsating fluid discharge effect also helps conserve water usage as a lesser volume of water is emitted from the rotary pulsator assembly than that which would be used if fluid was constantly discharged through each of the fluid discharge nozzles.

The features, aspects, and advantages of the present teachings will become better understood with reference to the following description, examples and appended claims.

### DRAWINGS

The drawings constitute a part of this specification and include exemplary embodiments of the disclosed subject matter illustrating various objects and features thereof, wherein like references are generally alike in the several views.

FIG. 1 is a perspective view of the rotary pulsator assembly.

FIG. 2 is an exploded view of the rotary pulsator assembly.

FIG. 3 is a top plan, cross sectional view of the rotary pulsator assembly taken along lines 3-3 of FIG. 1.

FIG. 4 is a cross sectional view in side elevation taken along lines 4-4 of FIG. 1.

FIG. 5 is a cross sectional view in side elevation taken along lines 5-5 of FIG. 3.

FIG. 6 is a cross sectional view in side elevation taken along lines 6-6 of FIG. 3.

FIGS. 7a through 7e are a series of cross sectional views similar to FIG. 5 showing the progression of the rotation of the valve with respect to the nozzle openings.

FIGS. 8a through 8f are a series of cross sectional views similar to FIG. 6 showing various embodiments of the valve configuration.

FIG. 9 is a perspective view of an alternative embodiment rotary pulsator assembly embodying principles of the disclosed subject matter.

FIG. 10 is an elevational view of the alternative embodiment rotary pulsator assembly.

FIG. 11 is an exploded view of an alternative embodiment rotary pulsator assembly.

FIG. 12 is a cross section view of the alternative embodiment rotary pulsator assembly of FIG. 11.

FIG. 13 is a cross section view of the alternative embodiment rotary pulsator assembly of FIG. 11.

FIG. 14 is an exploded view of an alternative embodiment rotary pulsator assembly.

FIG. 15 is a cross section view of the alternative embodiment rotary pulsator assembly of FIG. 14.

FIG. 16 is a cross section view of the alternative embodiment rotary pulsator assembly of FIG. 14.

### DETAILED DESCRIPTION

As required, detailed aspects of the disclosed subject matter are disclosed herein; however, it is to be understood that the disclosed aspects are merely exemplary of the subject matter, which may be embodied in various forms. Therefore, specific structural and functional details disclosed herein are not to be interpreted as limiting, but merely as a basis for the claims and as a representative basis for teaching one skilled in the art how to variously employ the present disclosed subject matter in virtually any appropriately detailed structure.

Certain terminology will be used in the following description for convenience in reference only and will not be limiting. For example, top, upper, bottom, and lower refer to the invention as orientated in the view being referred to. Said terminology will include the words specifically mentioned, derivatives thereof and words of similar meaning.

Referring to the drawings, an embodiment of a rotary pulsator assembly 10 for discharging fluid is shown. The rotary pulsator assembly 10 may be used with food processing systems including the washing of food parts such as chicken carcasses prior to or following evisceration. The rotary pulsator assembly 10 may be installed at points along a conveyor system or at specific stations where processing or packaging events take place. Operation of the rotary pulsator assembly 10 is by way of a gearbox 90 and motor 92.

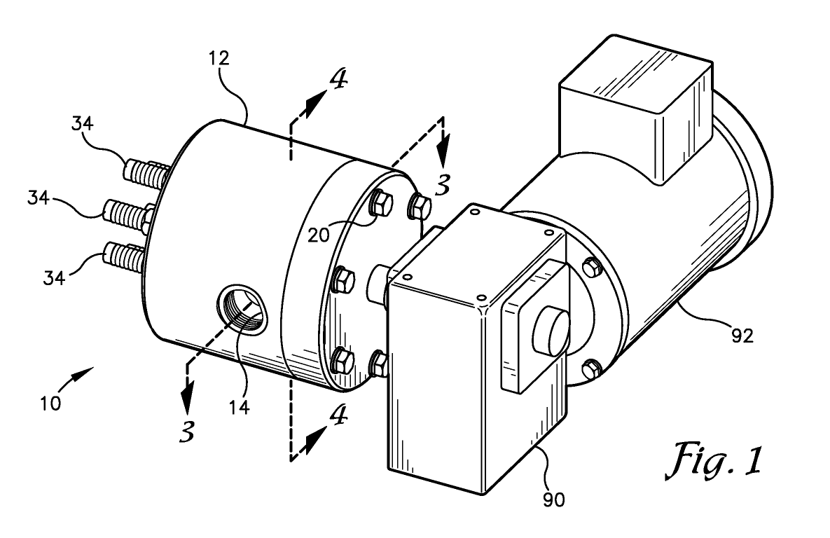

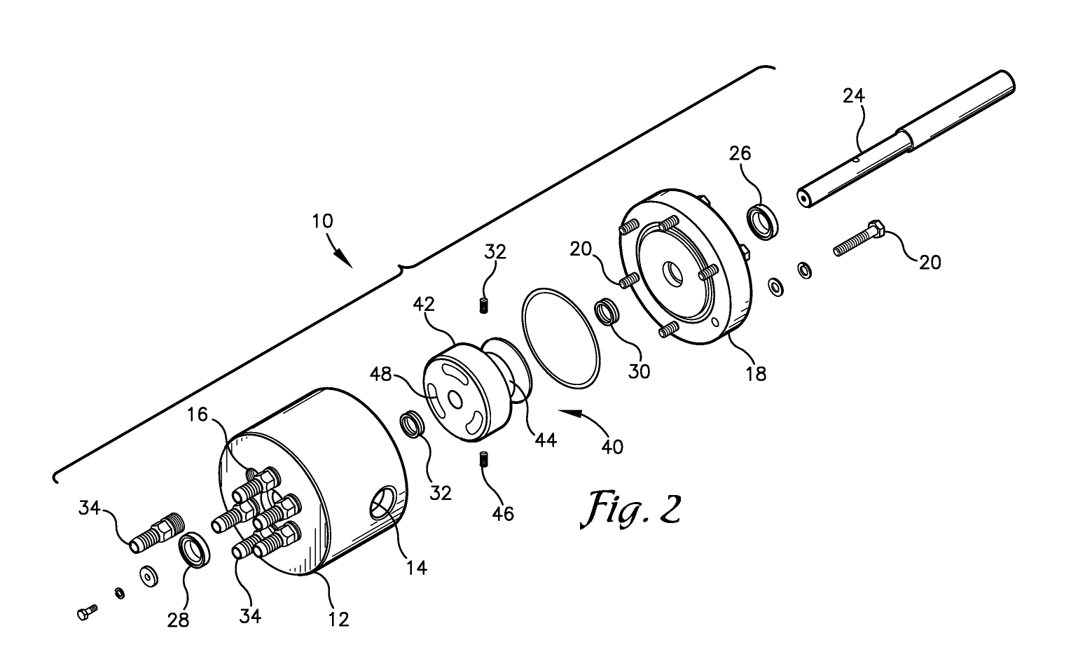

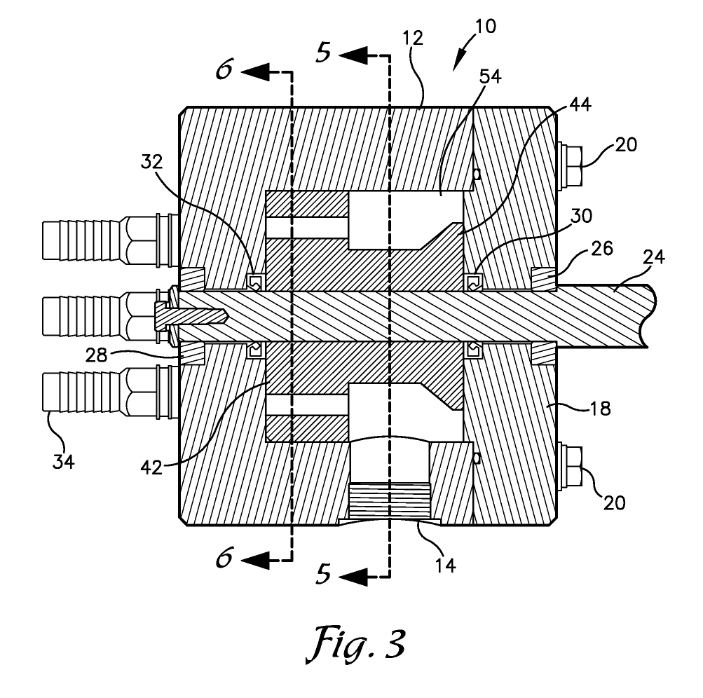

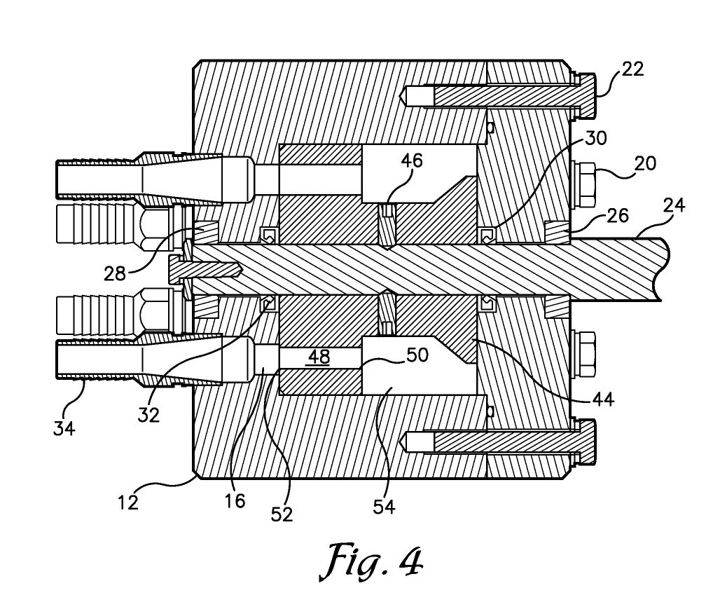

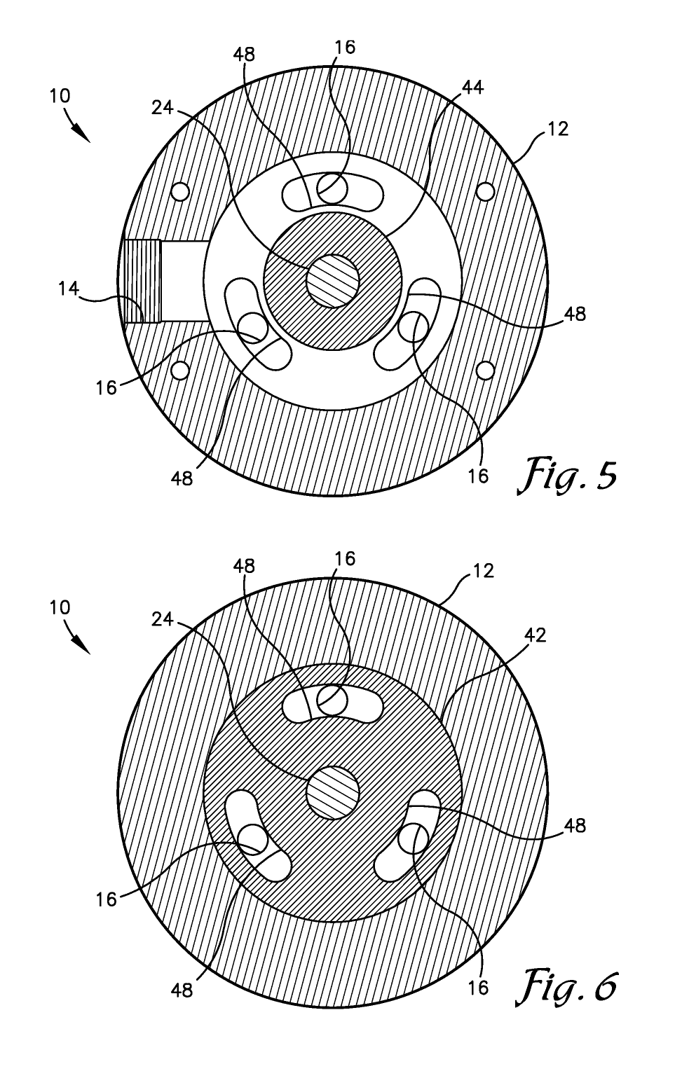

Referring to FIG. 1, the rotary pulsator assembly 10 is shown connected to a gearbox 90 and a motor 92. Referring to FIG. 2, the rotary pulsator assembly 10 generally includes a valve assembly 40 disposed within a housing 12. The housing 12 has an inlet 14 for receiving fluid from a supply line (not shown) connected to a fluid source. Fluid enters the inlet 14 and accumulates in an internal reservoir (FIGS. 3-4) before exiting the housing 12 through a plurality of fluid outlet ports 16 and fluid discharge nozzles 34. The fluid discharge nozzles 34 may include a fitting for attaching a conduit such as a hose barb fitting. The fluid outlet ports 16 are arranged in an annular array at a discharge area of the housing 12, and are internally threaded to securely receive the reciprocally threaded fluid discharge nozzles 34. The fluid discharge nozzles 34 are in fluid communication with a conduit (not shown) for discharge of the fluid, by example from a spray head in a spray nozzle assembly for washing or irrigating items during food processing. Fluid entering the housing 12 is generally under high pressure. The discharge of fluid from the rotary pulsator assembly 10 is similarly under substantial pressure allowing the fluid to effect a cleaning action upon the food parts.

The cleaning action of the fluid discharge process can be further enhanced by discharging the fluid from the housing 12 in an intermittent manner. However, the intermittent delivery of fluid under high pressure into the housing 12 can subject the supply lines and the rotary pulsator assembly 10 to damage from the repetitive surge of hydraulic pressure from the fluid, known as hydraulic shock or hammering. As such, intermittent release of fluid from the housing 12 by a rotating valve assembly can minimize the surge of hydraulic pressure into the housing 12 and decreases fluid use over a period of time.

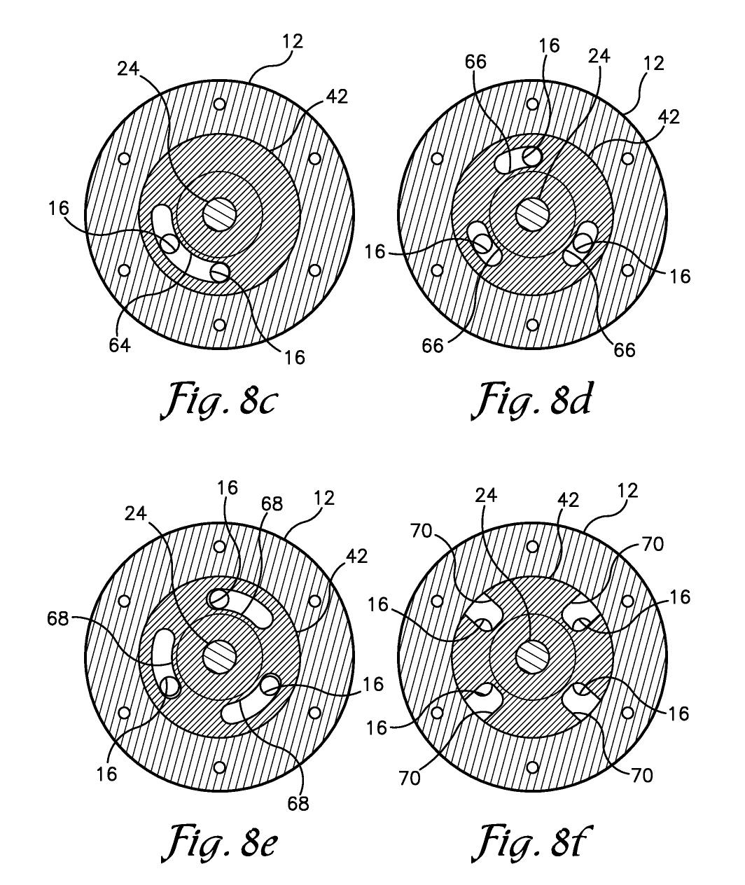

The housing 12 comprises a cylindrical internal chamber 54 in which an embodiment of a valve assembly 40 having three valve openings 48 is received. As described below, any number of valve openings may be used with the various valve assemblies. A cap 18 is held in secure engagement on the housing 12 by bolts 20. The valve assembly 40 comprises a cylindrical lower body 42 and an upper body 44. The lower body 42 has a diameter approximating that of the internal chamber 54. The upper body 44 has a smaller diameter than the lower body 42 to provide a fluid reservoir inside the internal chamber 54. The reservoir is formed in part by the gap between the outer circumferential edge of the upper body 44 and the internal wall of the housing 12. A shaft 24 is received in the housing 12 in rotational relationship though bearings 26 and 28, and is controlled by the gearbox 90. Gasket seals 30 and 32 surround the shaft 24 at engagement areas of the housing 12 to prevent leakage of fluid from the reservoir. The valve assembly 40 connects to the shaft 24 by set screws 46 so that the valve assembly 40 is operatively rotated as the shaft 24 rotates. The shaft 24 is driven by the motor 92 or other appropriate motive source. As the shaft 24 rotates, the lower valve body 42 rotates within the internal chamber 54. The lower valve body 42 has valve openings 48 which are positioned in an annular coaxial array about an axis of the valve assembly 40. Alternative embodiment valve assemblies are discussed below in conjunction with FIGS. 8a-8f. As the valve assembly 40 rotates, the annular array of valve openings 48 are configured to communicate with the annular array of fluid outlet ports 16 to enable fluid communication between the internal chamber 54 and the fluid discharge nozzles 34.

In operation, fluid enters the housing 12 through the inlet 14 and gathers in the internal chamber 54 around the periphery of the upper valve body 44. Fluid passes into each valve opening 48 through a first valve opening end 50. As each valve opening 48 comes into communication with a fluid outlet port 16 through rotation of the valve assembly 40, fluid then exits the valve opening 48 through a second valve opening end 52 into the fluid outlet port 16 and out of the housing 12 through the fluid discharge nozzle 34. Accordingly, fluid is discharged from the housing 12 whenever one or more valve openings 48 communicate with one or more fluid outlet ports 16, and fluid discharge is disrupted after a valve opening 48 passes out of communication with a fluid outlet port 16.

As the shaft 24 rotates the valve assembly 40, the valve openings 48 sequentially pass over each of the fluid outlet ports 16 such that fluid is discharged from the discharge nozzles 34 in a sequential pattern. Each valve opening 48 passes over, and communicates with, individual fluid outlet ports 16 for a particular duration such that a particular amount of fluid is discharged from a fluid discharge nozzle 34 at any given moment. As the valve opening 48 passes out of communication with a fluid outlet port 16, the valve body will occlude the fluid outlet port 16 preventing fluid discharge from the outlet port 16 until a valve opening 48 again passes into communication with the fluid outlet port 16. This repetitive sequence creates an effect whereby a burst of discharged fluid is produced from each fluid discharge nozzle 34 as the valve assembly 40 rotates. As the sequential fluid discharges are made, the overall cumulative fluid discharges from the housing 12 create a pulsating effect. The rate of rotation of the valve assembly 40 will affect the pulsating effect such that a faster rate of rotation will yield a more rapid pulsation. Increasing the number of fluid outlet ports 16 and valve openings 48 will change the pulsation effect. Although the fluid entering the internal chamber 54 is under pressure, rapid rotation of the valve assembly 40 essentially eliminates leaking of fluid from between the valve assembly 40 and the housing 12. Also, adjusting the dimension of the valve openings 48 will affect the duration of the fluid discharge bursts and the desired pulsation effect.

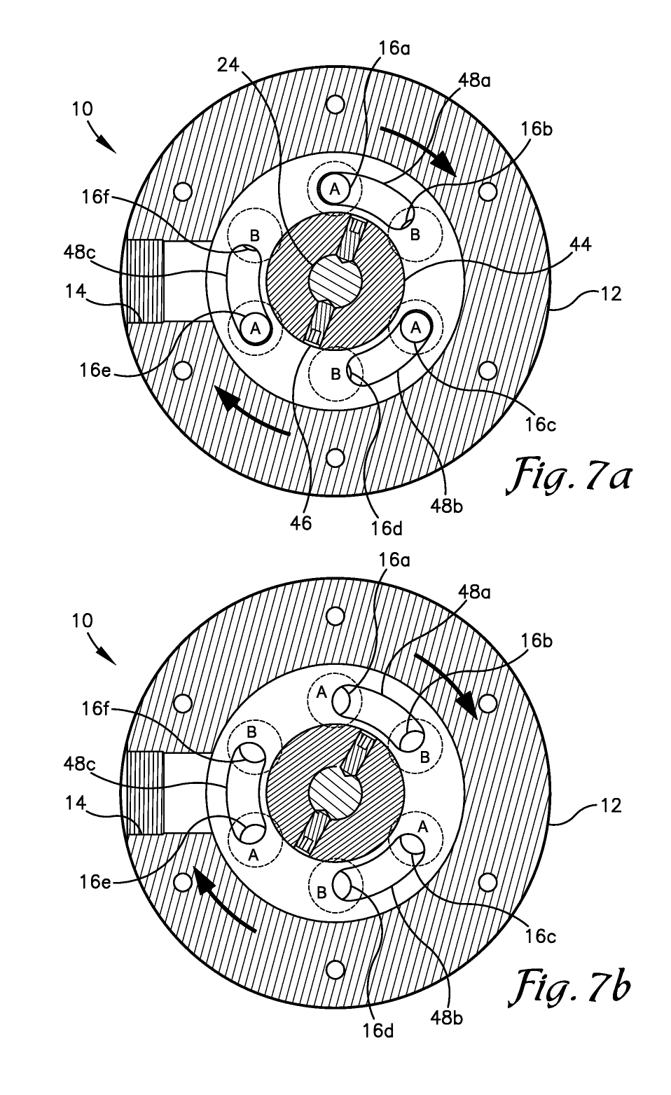

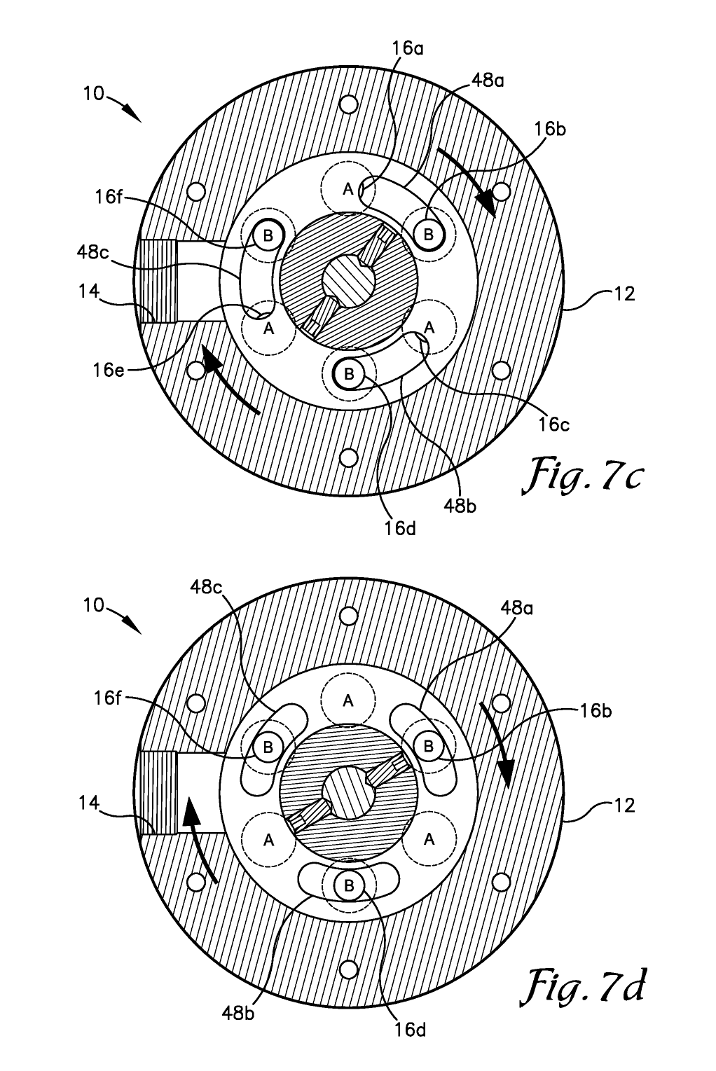

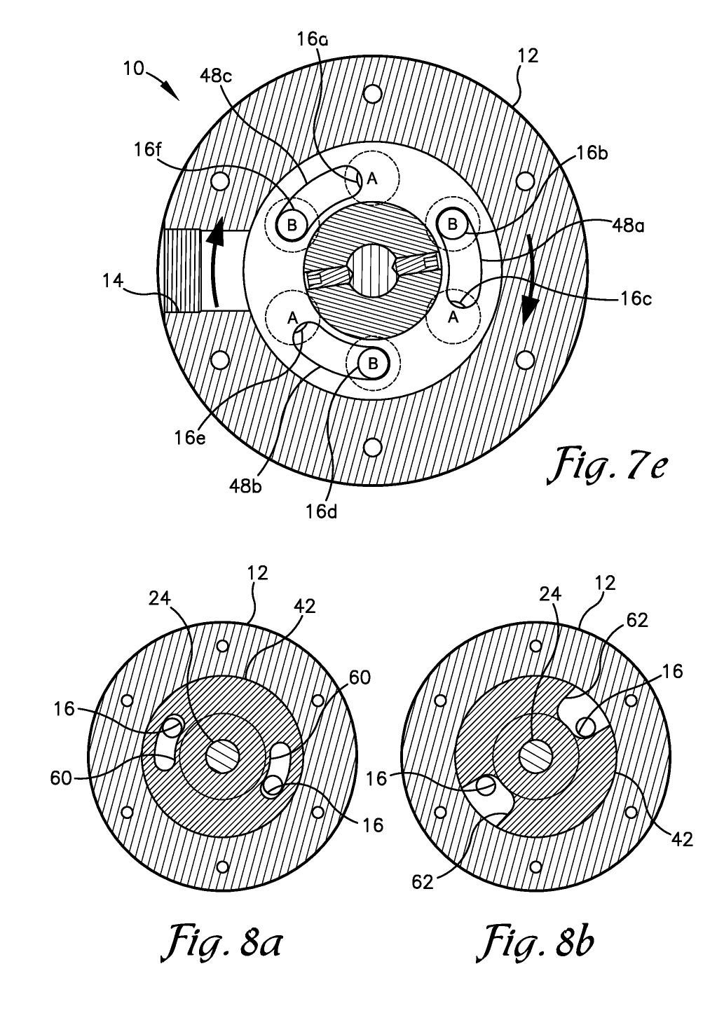

Referring to FIGS. 7a through 7e, the aforementioned sequential progression of valve openings 48 over fluid outlet ports 16 is shown wherein the effect of hammering is reduced because communication between each valve opening and at least one fluid outlet port remains open as the valve assembly 40 rotates thereby permitting uninterrupted fluid flow through each valve opening. The valve assembly 40 is shown in a first position in FIG. 7a whereby the lower body 42 has three arcuate valve openings 48a, 48b, and 48c, and the housing 12 has six fluid outlet ports 16a, 16b, 16c, 16d, 16e, and 16f. Valve opening 48a is shown in complete communication with fluid outlet port 16a thereby permitting the full flow of fluid therethrough. However, valve opening 48a is shown in partial communication with fluid outlet port 16b thereby permitting only limited fluid flow therethrough. Valve opening 48b is shown in complete alignment with fluid outlet port 16c and in partial communication with fluid outlet port 16d. Valve opening 48c is shown in complete communication with fluid outlet port 16e and partially aligning with fluid outlet port 16f.

The valve assembly 40 is shown in a second position in FIG. 7b whereby the lower body 42 has rotated in a clockwise direction such that valve opening 48a has moved into partial communication with fluid outlet ports 16a and 16b thereby decreasing the flow of fluid through fluid outlet port 16a and increasing the flow of fluid through fluid outlet port 16b. Valve openings 48b and 48c have also moved into similar positions whereby a decrease in the flow of fluid occurs through fluid outlet ports 16c and 16e, and an increase in the flow of fluid occurs through fluid outlet ports 16d, and 16f. Therefore, rotation of the valve assembly 40 from a first position to a second position has changed the fluid flow through the fluid outlet ports 16.

The valve assembly 40 is shown in a third position in FIG. 7c whereby the lower body 42 has rotated further in a clockwise direction such that valve opening 48a has moved into partial communication with fluid outlet port 16a thereby decreasing the flow of fluid through fluid outlet port 16a. However, valve opening 48a has moved into complete communication with fluid outlet port 16b thereby permitting the full flow of fluid therethrough. Valve openings 48b and 48c have also moved into similar positions whereby a decrease in the flow of fluid occurs through fluid outlet ports 16c and 16e, and an increase in the flow of fluid occurs through fluid outlet ports 16d and 16f. Therefore, further rotation of the valve assembly 40 from a second position to a third position has changed the fluid flow through the fluid outlet ports 16 and propagates a pulsing fluid discharge effect about the fluid outlet ports.

The valve assembly 40 is shown in a fourth position in FIG. 7d whereby the lower body 42 has rotated further in a clockwise direction such that valve opening 48a has moved completely past fluid outlet port 16a thereby disrupting the flow of fluid through fluid outlet port 16a. However, valve opening 48a remains in complete communication with fluid outlet port 16b thereby permitting continued full flow of fluid therethrough. Valve openings 48b and 48c have also moved into similar positions whereby the flow of fluid through fluid outlet ports 16c and 16e has been disrupted, and the flow of fluid through fluid outlet ports 16d and 16f is maintained.

The valve assembly 40 is shown in a fifth position in FIG. 7e whereby the lower body 42 has rotated further in a clockwise direction such that valve opening 48a remains in complete communication with fluid outlet port 16b thereby permitting continued full flow of fluid therethrough. However, valve opening 48a has moved into partial communication with fluid outlet port 16c thereby permitting only limited fluid flow therethrough. Valve openings 48b and 48c have also moved into similar positions whereby the flow of fluid through fluid outlet ports 16d and 16f is maintained, and the flow of fluid through fluid outlet ports 16e and 16a has increased. As the valve assembly 40 rotates within the housing 12, the rotation sequence of the lower body 42 shown in FIGS. 7a-7e is repeated to propagate the staggered pulsing fluid discharge effect from the rotary pulsator assembly 10. Although a clockwise rotation of the valve assembly 40 has been shown and described, those skilled in the art will appreciate that the staggered pulsing fluid discharge effect shown and described above may similarly be created by a counter-clockwise rotation of the valve assembly 40.

Referring to the embodiments in FIGS. 8a through 8f, valve openings in the lower valve body 42 are shown in various configurations. The number, length, and volume of valve openings effect the pulsating effect of the rotary pulsator assembly 10. One or more valve openings may be provided in lower valve body 42, and one or more fluid outlet ports may be provided in the housing 12. The more fluid outlet ports provided in the lower valve body 42 the greater the number of fluid discharge bursts that can be emitted in any given period of time. A longer duration fluid discharge burst can be created by lengthening a valve opening or slowing rotation of the valve assembly 40 which exposes a fluid outlet port to an open condition for a longer period of time as the valve opening passes over the fluid outlet port.

FIG. 8a shows a lower valve body 42 with a pair of valve openings 60 having an arcuate, slot shape. FIG. 8b shows a pair of valve openings 62 having a cup or U-shape. The volume of space created by the valve opening 62 in FIG. 8b is larger than the volume of space created by the valve opening 60 in FIG. 8a.

FIG. 8c shows a lower valve body 42 with a valve opening 64 having an arcuate, elongated slot shape where the length of the opening is sufficient to span the distance between two consecutive fluid outlet ports 16. Therefore, when the valve opening 64 passes over any particular fluid outlet port 16, fluid will be discharged from the fluid outlet port 16 for a relatively long duration so as to permit a relatively long fluid discharge burst before the valve opening 64 passes out of alignment with the fluid outlet port 16.

FIGS. 8d-8e show a lower valve body 42 with three valve openings. The valve openings 68 in FIG. 8e are larger than the valve openings 66 in FIG. 8d. Therefore, were the lower valve bodies 42 in each of FIGS. 8d and 8e rotated at the same rate, the duration of fluid discharge from each fluid discharge nozzle in FIG. 8e would be greater than the duration of fluid discharge from the each fluid discharge nozzle in FIG. 8d. Likewise, the valve openings 70 shown in FIG. 8f have a relatively short opening aperture such that when the valve openings 70 pass over a fluid outlet port 16 is will be of relatively short duration creating a very brief fluid discharge burst before the valve opening 70 passes out of alignment with the fluid outlet port 16.

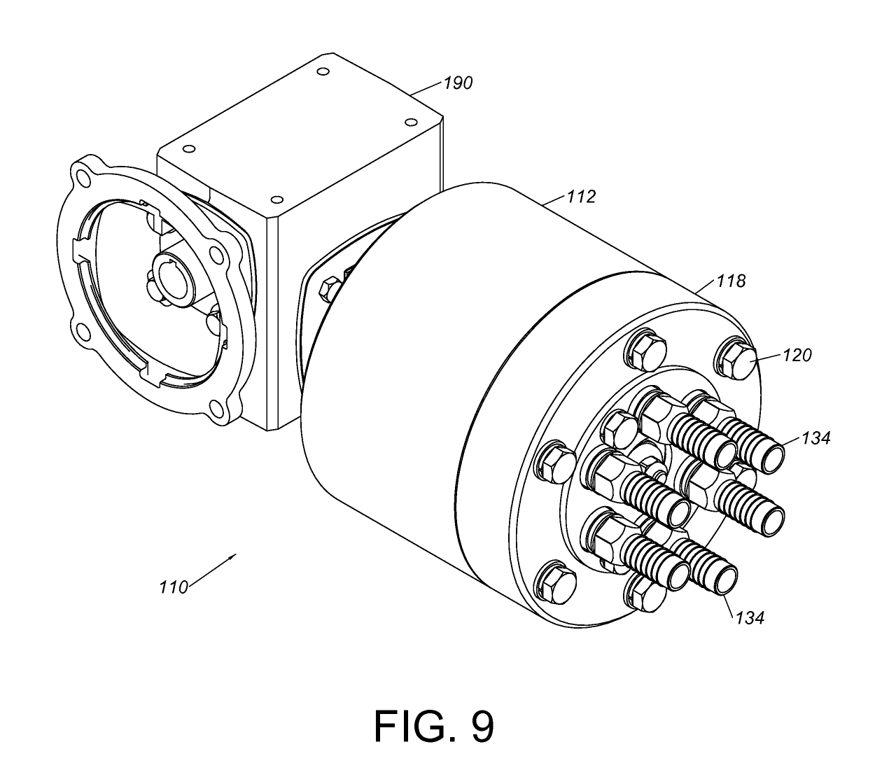

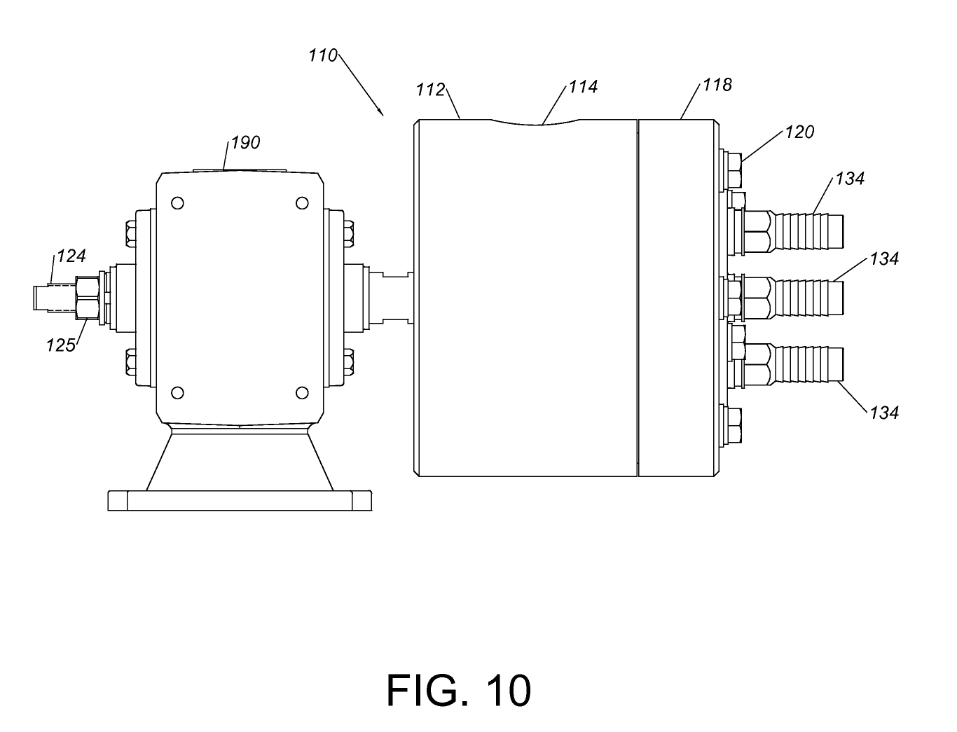

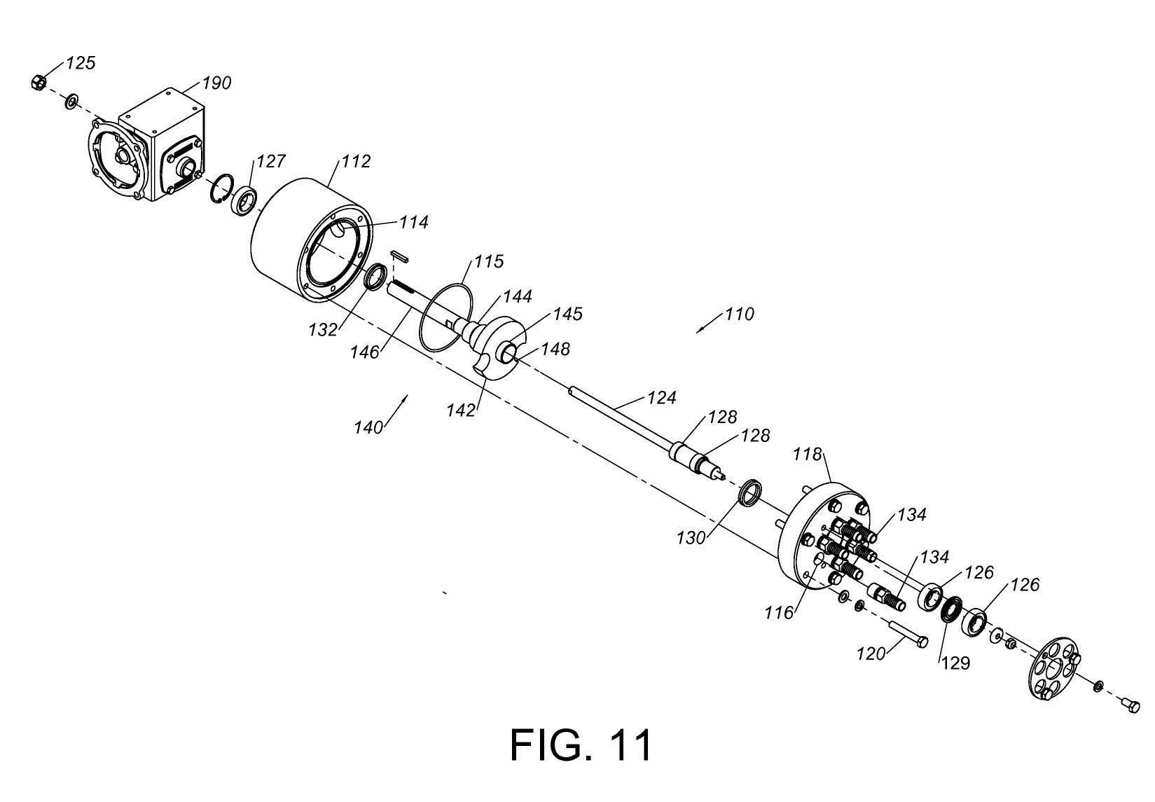

Referring to FIGS. 9-13, an alternative embodiment rotary pulsator assembly 110 for discharging fluid embodying principles of the disclosed subject matter is shown and described. FIGS. 9-11 show the rotary pulsator assembly 110 operably connected to a gearbox 190. The gearbox 190 is operably connected to a motor (not shown). The rotary pulsator assembly 110 generally includes a tube-like valve assembly 140 disposed within a housing, wherein the housing includes a cylindrical housing 112 and cap 118. The cap 118, located at the front of the rotary pulsator assembly 110, contains a plurality of fluid outlet ports 116 arranged in an annular coaxial array. The cap 118 may be secured to the housing 112 by fasteners including bolts 120 which are threadably received within the front of the housing 112. An inlet 114 in the housing 112 allows for connection of a conduit (not shown) connected to a fluid source for supplying fluid to the rotary pulsator assembly 110. Fluid enters the inlet 114 at the rear of the rotary pulsator assembly 110 and accumulates in an internal chamber 154 before exiting the housing 112 at the front through a plurality of fluid discharge nozzles 134 that are threadably received within the fluid outlet ports 116. The fluid discharge nozzles 134 may comprise a fitting for attaching a conduit such as a hose barb fitting. The fluid discharge nozzles 134 may be in fluid communication with a conduit (not shown) for discharging the fluid upon the animal carcasses.

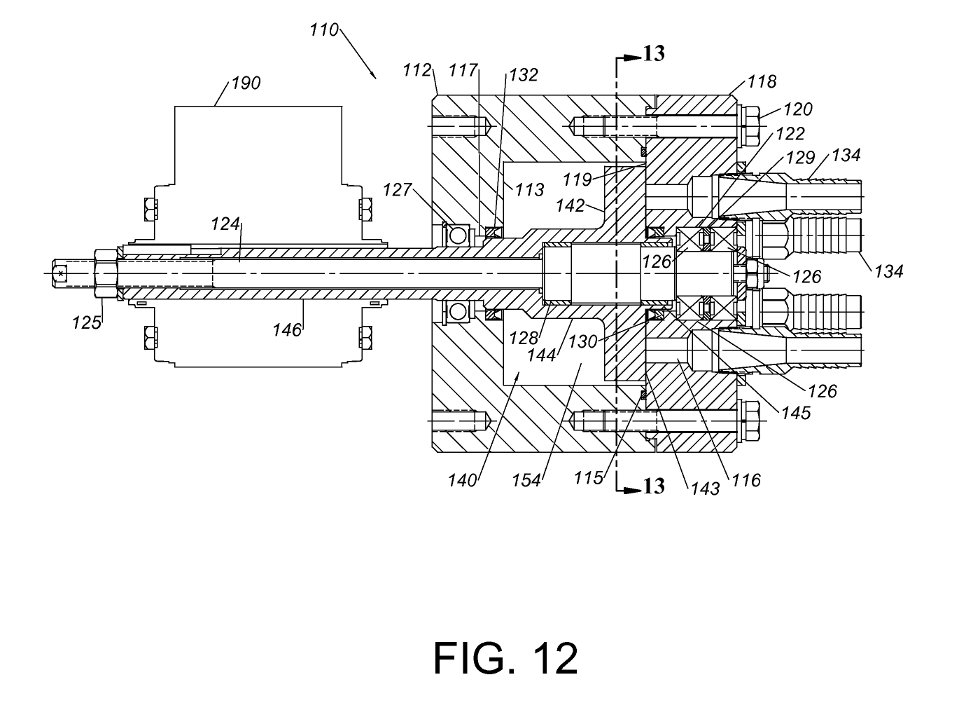

FIG. 12 shows a cross section of the rotary pulsator assembly 110 wherein the valve assembly 140 is in a first position. The valve assembly 140 comprises a wide lower body 142 and a narrow upper body 144, with a shaft 146 extending longitudinally rearward therefrom. A sleeve 145 extends from the bottom of the lower body 142 and is received within the cap 118. The valve assembly 140 is mounted on a shaft 124, and extends from the sleeve 145 within the cap 118 through the back wall 113 of the housing 112, terminating at the gearbox 190. The shaft 146 is mechanically received within the gearbox 190 thereby operably controlling rotation of the valve assembly 140. In addition, the rearward interior surface of the shaft 146 is threadably received on the rear of the shaft 124. Without limitation on the generality of useful materials, the valve assembly 140 may be manufactured from plastic or metal, preferably stainless steel. The shaft 124 extends from within the cap 118 into the valve assembly 140, terminating at the rear and exterior of the gearbox 190.

At the front of the rotary pulsator assembly 110, the shaft 124 is held in place linearly to the cap 118 by bearings 126 disposed within a bore 122 allowing the shaft 124 to rotate. A seal 130 disposed within the bore 122 prevents fluid from leaking from the chamber 154 through the bore 122. Distance rings 129 offset the inner race and outer race of each bearing 126 to minimize the distance between the ball bearing and the inner surface of the race, thereby minimizing the lateral movement of the shaft 146. At the rear of the rotary pulsator assembly 110, the valve assembly 140 is sealed at the back wall 113 by a seal 132 disposed within the bore 117, and rotates within the exterior back wall 113 by a bearing 127 disposed within the bore 117. The bearings 126 and 127, bushings 128, and seals 130 and 132, allow the valve assembly 140 to rotate within the housing 112. The bushings 128 are manufactured from a resilient material including bronze, and are mounted on the shaft 124 and located within the valve assembly 140 creating a space between the valve assembly 140 and the shaft 124. The seals 130 and 132 prevent fluid from leaking from the chamber 154, and an O-ring 115 at the front of the housing 112 creates a sealing relationship between the housing 112 and cap 118 preventing fluid from leaking from the chamber 154 at that interface.

The inner face 119 of the cap 118 and the bottom surface of the lower body 142 are adjacent. The distance between the inner face 119 of the cap 118 and the face of the lower body 142 forms a gap 143 that may be substantially about 0.30 millimeters in order to allow debris that may be present in the fluid to pass out of the chamber 154 through the fluid discharge nozzles 134. This close arrangement between the cap 118 and lower body 142 is permitted by minimizing the lateral movement of the shaft 124 within the bearing 126, and lateral movement of the valve assembly 140 on the shaft 124. In an embodiment, lateral movement of the shaft 124 is minimized by use of the distance ring 129 disposed between the bearings 126. In an embodiment, the distance between the lower body 142 and the inner face 119 may be changed by adjusting a fastener, including a nut 125, threadably received on the rear of the shaft 124 at the exterior of the gearbox 190. Loosening the nut 125, and rotating shaft 124 causes the threads at the rear of shaft 146 to engage the threads at the rear of shaft 124 moving the valve assembly 140 rearward within the internal chamber 154. Once the desired distance between the lower body 142 and the inner face 119 is achieved, the nut 125 may be tightened locking the shaft 124 and valve assembly 140 together fixing the gap. For example, if there was a problem with the motor or gearbox 190 that prevented the valve assembly 140 from rotating, the nut 125 may be backed off of the shaft 146 away from the rear of the gearbox 190 thereby allowing the valve assembly 140 to move rearward drawing the lower body 142 away from the inner face 119, enlarging the gap 143, and allowing the fluid to freely flow from the chamber 154 through the valve openings 148, fluid outlet ports 116, and fluid discharge nozzles 134. The valve assembly 140 may be returned to the starting position by advancing the nut 125 toward the front of the rotary pulsator assembly 110.

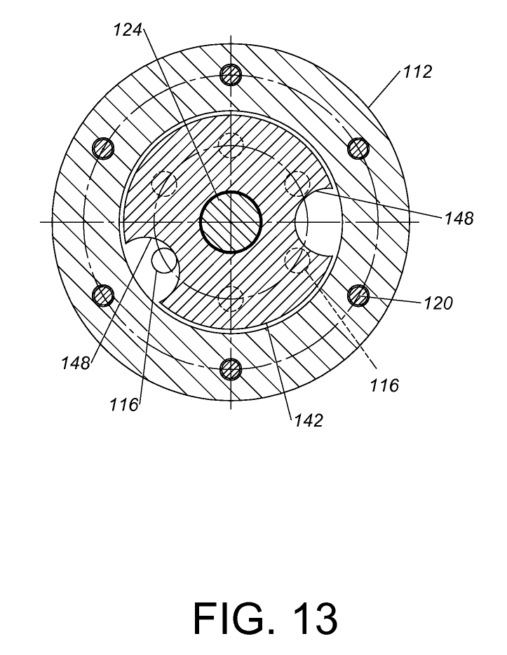

Referring to FIG. 13, a cross section of the rotary pulsator assembly 110 is shown whereby the valve openings 148 and fluid outlet ports 116 may be observed. Although only two scalloped valve openings 148 are shown in the lower body 142, the various annular coaxial arrangements of fluid outlet ports and valve openings described above may be employed in this embodiment. Furthermore, the valve opening 148 and fluid outlet ports 116 are aligned such that as the valve assembly 140 rotates, the valve openings 148 communicate with the fluid outlet ports 116 to enable fluid communication between the internal chamber 154 and the fluid discharge nozzles 134. The hammering effect of water entering and exiting the rotary pulsator assembly 110 is reduced because communication between each valve opening 148 and at least one fluid outlet port 116 remains open as the valve assembly 140 rotates thereby permitting uninterrupted fluid flow from the chamber 154.

In operation, this embodiment of the rotary pulsator assembly 110 functions in the same manner as the embodiments above whereby rotation of the valve assembly 140 causes fluid in the chamber 154 to exit the rotary pulsator assembly 110 intermittently in a sequential pattern. Employing various arrangements of valve openings 148 and fluid outlet ports 116 can affect the volume of fluid discharge and length of fluid discharge from the rotary pulsator assembly 110.

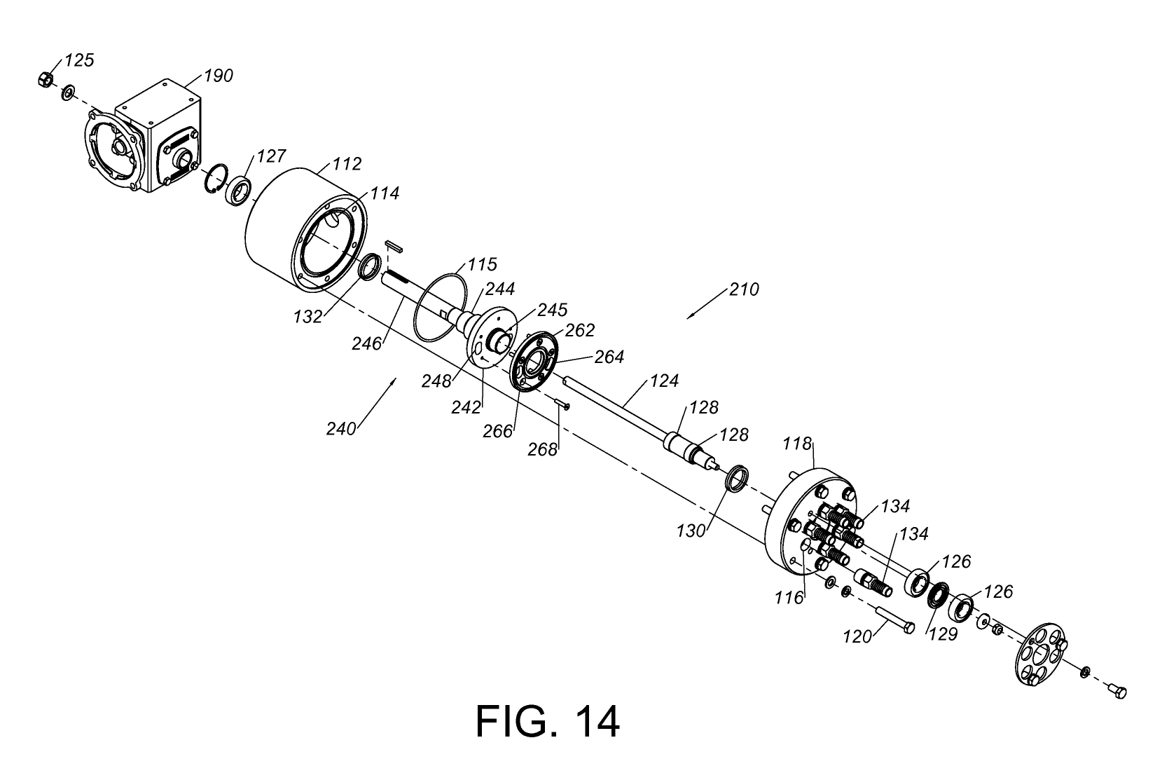

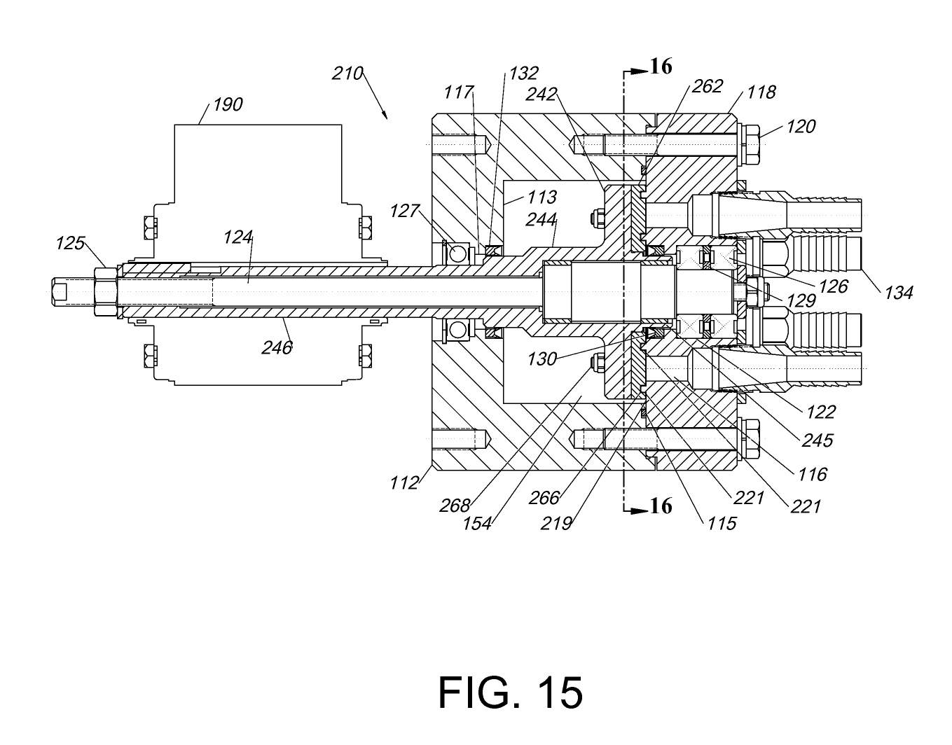

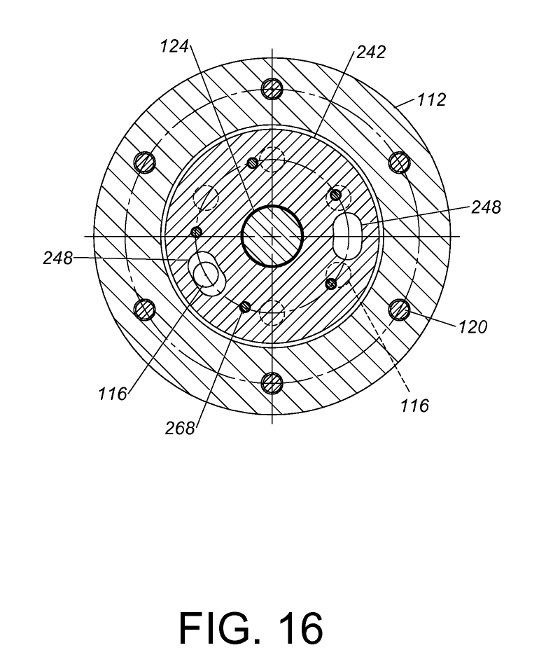

Referring to FIGS. 14-16, an alternative embodiment rotary pulsator assembly 210 similar to the rotary pulsator assembly 110 above has a modified valve assembly 240 embodying principles of the disclosed subject matter is shown and described. The valve assembly 240 includes a wide lower body 242 and a narrow upper body 244, with a shaft 246 extending longitudinally rearward therefrom. The rearward interior surface of the shaft 246 is threadably received on the rear of the shaft 124. A sleeve 245 extends from the bottom of the lower body 242 and is received within the cap 118. A gap may be provided between the interior surface of the housing 122 and the lower body 242.

A seal 262 secured to the bottom surface of the lower body 242 has one or more grooves 266 co-centric with the shaft 124 that interface with one or more co-centric rings 221 extending from the inner face 219 of the cap 118, forming a labyrinth seal. The seal 262 is secured to the lower body 242 by fasteners, including screws 268. The screw 268 has a head that is counter sunk within the seal 262 and is secured to the lower body 242 by nuts. The seal 262 substantially limits the path of fluid exiting the chamber 154 through the valve openings 248 in the valve assembly 240 either by having physical contact between the seal 262 and the cap 118, or the seal 262 may be set off a distance from the inner face 219 of the cap 118 thereby creating a frictionless sealing relationship between the cap 118 and the seal 262.

Similar to the embodiment described above, the distance between the cap 118 and the seal 262 may be modified by moving the valve assembly 240 on the shaft 124. Loosening the nut 125, and rotating shaft 124 causes the threads at the rear of the shaft 246 to engage the threads at the rear of shaft 124 moving the valve assembly 240 rearward within the internal chamber 154. Once the desired distance between the seal 262 and the inner face 219 is achieved, the nut 125 may be tightened locking the shaft 124 and valve assembly 240 together thereby fixing the gap between them.

In use, the above rotary pulsator assemblies are connected to a fluid source that supplies fluid for the chamber. The valve assemblies are rotated by a motor causing fluid to discharge from the chamber through the fluid discharge nozzles when the outlet ports communicate with the valve openings. The speed at which the valve assembly is rotated may vary depending upon the pulsating effect desired. Rapid rotation of the valve assembly causes rapid pulsation of fluid in which it appears that the fluid exiting the fluid outlet ports does not stop. It is the periodic blockage of the fluid outlet port by the valve assembly that decreases the overall volume of fluid that exits the rotary pulsator assembly for a given period of time resulting in an overall savings of fluid used thereby decreasing the cost of processing operations.

It will be appreciated that the rotary pulsator assemblies described above can be used for various other applications in which the discharge of fluid is desired. Moreover, the rotary pulsator assemblies can be fabricated in various sizes and from a wide range of suitable materials, using various manufacturing and fabrication techniques.

It is to be understood that while certain aspects of the disclosed subject matter have been shown and described, the disclosed subject matter is not limited thereto and encompasses various other embodiments and aspects.

What is claimed is:

1. A valve, comprising:
a housing extending between a front end and a back end comprising a tubular chamber;
a fluid inlet port communicating with the chamber;
a plurality of fluid outlet ports disposed within the housing front end communicating with the chamber;
a valve assembly disposed within the housing, the valve assembly extending between a lower body and an upper body, the lower body disposed and rotatably mounted within the chamber between the fluid inlet port and the plurality of fluid outlet ports, the lower body adjacent the housing front end;
at least one valve opening disposed within the lower body communicating with the chamber at a first end and the fluid outlet ports at a second end; and
the valve assembly rotatable to sequentially pass the valve opening second end into communication with a fluid outlet port thereby causing a sequential discharge of fluid from the chamber.

2. The valve of claim 1 in which the valve opening communicates with at least two adjacent fluid outlet ports.

3. The valve of claim 2, in which the fluid outlet ports are disposed in an annular array.

4. The valve of claim 3, in which a plurality of valve openings are disposed in an annular array.

5. The valve of claim 4, in which a spacing of the plurality of valve openings are configured whereby each valve opening simultaneously communicates with a fluid outlet port.

6. The valve of claim 4, in which a spacing of the plurality of valve openings are configured whereby each valve opening aligns with a fluid outlet port in a staggered sequence.

7. The valve of claim 4, in which the plurality of valve openings are arranged to intermittently sequentially communicate with at least one fluid outlet port.

8. The valve of claim 1, in which the valve opening has an arcuate shape.

9. The valve of claim 1, further comprising:
a shaft received within the valve assembly, the shaft extending between a front end and a back end, the shaft front end rotatably received within the housing front end, and the shaft back end extending through the housing back end.

10. The valve of claim 9, wherein the shaft back end is threadably received within the valve upper body for increasing and decreasing the distance between the valve assembly lower body and housing front end.

11. The valve of claim 10, further comprising a fastener threadably received on the shaft back end for securing the valve assembly to the shaft.

12. A valve, comprising:
a housing extending between a front end and a back end comprising a tubular chamber;
a fluid inlet port communicating with the chamber;
a plurality of fluid outlet ports disposed within the housing front end communicating with the chamber;
a shaft extending between a front end and a back end, the shaft front end rotatably received within the housing front end, and the shaft back end extending through the housing back end;
a valve assembly mounted on the shaft, the valve assembly extending between a lower body and an upper body, the lower body disposed within the chamber between the fluid inlet port and the plurality of fluid outlet ports, the lower body adjacent the housing front end;
the shaft back end being threadably received within the valve upper body;
at least two valve openings disposed within the lower body in an annular array communicating with the chamber at a first end and the fluid outlet ports at a second end; and
the valve assembly rotatable to sequentially pass the valve opening second end into communication with a fluid outlet port thereby causing a sequential discharge of fluid from the chamber.

13. The valve of claim 12, in which the plurality of outlet ports are disposed in an annular array, and each valve opening communicates with a single fluid outlet port.

14. The valve of claim 13, in which each valve opening communicates with at least two adjacent fluid outlet ports.

15. The valve of claim 13, in which a spacing of the plurality of valve openings are configured whereby each valve opening simultaneously communicates with a fluid outlet port.

16. The valve of claim 13, in which the plurality of valve openings are arranged to intermittently sequentially communicate with at least one fluid outlet port.

17. The valve of claim 12, further comprising a valve seal secured to the lower body disposed between the lower body and the fluid outlet ports.

18. The valve of claim 11, further comprising a fastener threadably received on the shaft back end for securing the valve assembly to the shaft.

19. The valve of claim 17, wherein:
the housing including an inner face proximal to the plurality of outlet ports;
a ring extending from the inner surface and circumscribing the fluid outlet ports; and
a grove at the valve seal that interfaces with the ring.

20. A method for providing a pulsating discharge of fluid, the method comprising:
providing a housing comprising a front end and a back end defining a tubular chamber having a fluid inlet port communicating with the chamber and a plurality of fluid outlet ports communicating with the chamber;
providing a shaft extending between a front end and a back end, the shaft front end rotatably received within the housing front end, and the shaft back end extending through the housing back end;
providing a valve assembly mounted on the shaft with at least one valve opening communicating with the chamber and the fluid outlet ports;
rotating the valve assembly to sequentially pass the at least one valve opening into communication with a fluid outlet port to cause a sequential discharge of fluid from the chamber.

21. The method of claim 20, in which the fluid outlet ports are disposed in an annular array.

22. The method of claim 21, in which each valve opening communicates with at least two adjacent fluid outlet ports.

23. The method of claim 22, further comprising:
a plurality of valve openings disposed in an annular array in which the spacing of the respective valve openings are configured to simultaneously align with the fluid outlet ports to cause a sequential pulsating discharge of fluid from the chamber as the valve assembly is rotated.

24. The method of claim 23, in which the spacing of the valve openings are configured to align in a staggered sequence with the fluid outlet ports to cause a staggered pulsating discharge of fluid from the chamber as the valve assembly is rotated.

25. The method of claim 20, wherein the valve assembly is threadably received on the shaft for increasing and decreasing the distance between the valve assembly and housing font end.
